(19) United States
(12) Patent Application Publication
(10) Pub. No.: US 2016/0134959 A1
(43) Pub. Date: May 12, 2016

(54) MAGNETIC TRANSPORTABLE EARBUD CHARGING SYSTEM

(71) Applicant: Alpha Audiotronics, Inc., New York, NY (US)

(72) Inventor: Jonathan Everett Shaffer, Huntingdon Valley, PA (US)

(21) Appl. No.: 14/538,475

(22) Filed: Nov. 11, 2014

(51) Int. Cl. H04R 1/10

(52) U.S. Cl. CPC H04R 1/1025

(57) ABSTRACT

A dock for charging one or more earbuds includes a housing configured to receive the earbuds and recharge them via an extendable plug, induction coil, or other components. The dock also contains its own rechargeable battery that electrically connects to both the electrical transfer components and the earbud charging contacts. Thus, the earbuds may be charged by an external power source when connected to or in inductive proximity to it, and by the battery when not connected to or in range of the power source.

### BACKGROUND

This patent document relates to a transportable earbud charging dock that serves as an electrical charger and storage device for rechargeable wireless audio earbuds.

Wireless audio earbuds (“earbuds”) are a convenient way to eliminate tangled wires that impede a user's full range of motion. Wireless earbuds are commonly tethered together (although they communicate wirelessly with a mobile device) in order to prevent loss, given inadequate forms of storage for untethered earbuds. Maintaining wireless earbuds can be inconvenient to a user because they require regular electrical charge.

While there are some limited examples of existing charging devices for wireless earbuds contained within the prior art, these devices exhibit several inconveniences. For example, existing devices must be opened to access earbuds and closed to protect them, do not securely hold the earbuds, require an external proprietary charging connecting cord to reach a power source, and cannot be used unless an external power source is present.

This document describes a device that addresses some or all of the issues described above.

### SUMMARY

In an embodiment, a dock for recharging one or more earbuds includes a housing having a first end with a first earbud receiving aperture, and optionally an opposite second end with a second earbud receiving aperture. Each earbud receiving aperture is configured to receive an earbud into the housing and includes one or more magnetic components configured to engage a corresponding magnetic component of the earbud to secure the earbud within the aperture. The system also includes a power transfer component, along with and one or more electrical contacts that are configured to transfer power from the power transfer component to the earbuds when the power transfer component exhibits a charge and the earbuds are magnetically held within the apertures.

Optionally, the power transfer component may include: (1) a plug that is moveable between an extended position and a retracted position and configured to receive charge from a power source via the plug when the plug is connected to the power source; a rechargeable dock battery; and (2) a conductive element that, when the extended plug is connected to a power source, electrically connects the plug to the one or more electrical contacts and to the rechargeable dock battery to enable a simultaneous charge of the rechargeable dock battery and of each earbud when placed in its earbud receiving aperture.

The plug that is moveable between an extended position and a retracted position and configured to receive charge from a power source via the plug when the plug is connected to the power source. For example, the plug may include a mechanically extendable AC connector or multi-pin connector. The dock also includes a rechargeable dock battery. This embodiment also includes a conductive element that, when the extended plug is connected to a power source, electrically connects the plug to the one or more electrical contacts and to the rechargeable dock battery to enable a simultaneous charge of the rechargeable dock battery and of each earbud when placed in its earbud receiving aperture. The one or more conductive elements may be configured to transfer charge from the rechargeable battery to the electrical contacts when the plug is not connected to a power source. Optionally, the dock also may include a spring and an activator that, when activated, causes the spring to force the plug from the retracted position to the extended position.

Alternatively, the power transfer component may include: (1) a rechargeable dock battery; (2) an induction coil; and (3) a conductive element that electrically connects the induction coil to the rechargeable dock battery and the electrical connectors to enable a simultaneous charge of the rechargeable dock battery and of each earbud when placed in its earbud receiving aperture and when the induction coil is energized.

Optionally, this embodiment of the system also may include an induction charging unit comprising a charging unit induction coil, and one or more components configured to electrically connect the induction coil to a power source so that the charging unit induction coil energizes when electrically connected to the power source. The charging unit is configured to receive the dock and transfer charge from the charging unit induction coil to the dock induction coil when the dock is proximate the charging unit.

In any of the embodiments described above, each earbud may include a grip having a shape and a lateral dimension. The housing of the dock also may have a shape and lateral dimension corresponding to that of a grip of each earbud so that when an earbud is placed in one of the earbud receiving apertures, its earbud grip will extend from the housing. For example, the shape of the grip may be circular, and the shape of the housing may be cylindrical.

Optionally, in any embodiment described above, each earbud receiving aperture may include a magnetic component positioned to engage and secure the earbud when the earbud is positioned within the earbud receiving aperture. Alternatively or in addition, the electrical contacts in each earbud receiving aperture may include a magnet that secures the earbud to the aperture when the earbud is positioned within the aperture.

In various embodiments, the magnetic component of each earbud receiving aperture may comprise a magnetic coated surface, ring, strip or disk. Similarly, the magnetic component of each earbud may comprise a magnetic ring, disk or bar. Or, the magnetic component of each earbud may comprise a speaker. The magnetic component of each earbud receiving aperture may have a first polarity, and the magnetic component of each speaker may have a second polarity that is opposite the first polarity.

### BRIEF DESCRIPTION OF THE DRAWINGS

FIG. 1A is a front view of an example of two wireless audio earbuds.

FIG. 1B is shows the earbuds of FIG. 1A with various internal electrical components. FIG. 1C illustrates an alternate embodiment in which the earbuds include induction coils for charging purposes.

FIG. 2 is a diagram showing certain internal mechanical and electrical components of an earbud charging dock.

FIG. 3A is a front view of the earbud dock of FIG. 2 with earbuds from FIG. 1A entering the apertures. FIG. 3B is an internal view of the earbud dock with two earbuds docked.

FIG. 4 is a diagram of various electrical components within an earbud charging dock.

FIG. 5 is an alternative configuration of an earbud charging dock.

FIG. 6A shows an earbud charging dock with an extendable AC plug for engaging a power source. FIGS. 6B and 6C show an earbud charging dock with an extendable USB plug for engaging a power source.

FIG. 7 shows an example of an induction charging station.

### DETAILED DESCRIPTION

As used in this document, the singular forms “a, “and,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

The term “earbud” refers to a device designed to fit within the ear of a human, and which emits audio signals that the earbud receives from a mobile electronic device. Examples of earbuds include in-ear headphones, hearing aids and the like.

The embodiments described in this document may help eliminate the inconvenience of additional charging cables, wires, and tethered earbuds by including features such as: (1) using a docking system that is connectable to common power sources, to provide electrical charge to wireless earbuds; (2) embedding a magnetic dock within an earbud dock to ensure secure storage and sealed transport of the earbuds; (3) allowing for untethered earbud storage, reducing pull and tangling commonly associated with earbuds connected to a mobile device with a wire and tethered wireless earbuds; and/or (4) allowing for attachment to a key chain or other securing structure so the dock need not be transported as a standalone device.

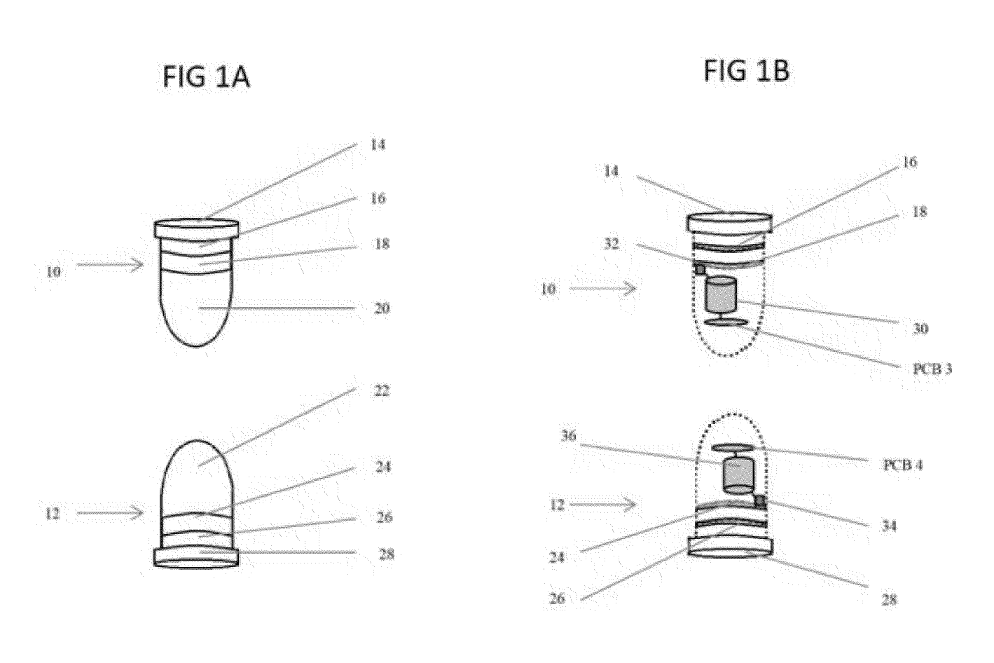

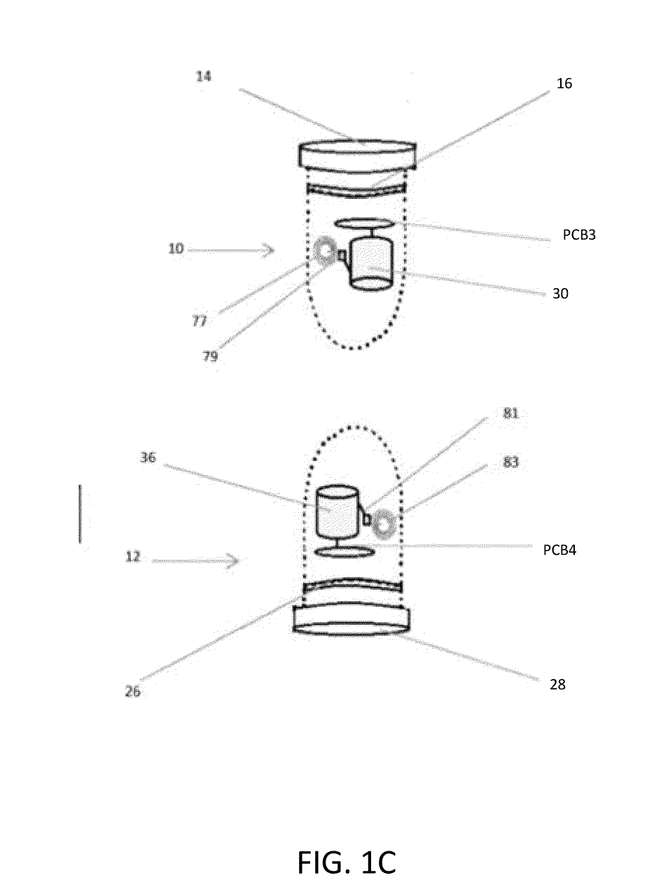

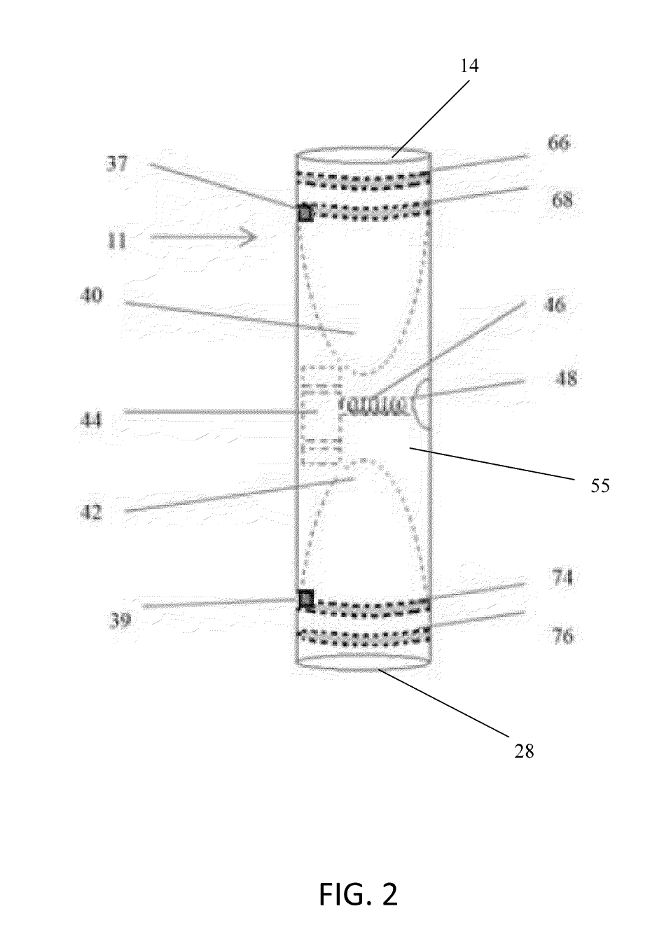

FIG. 1A and FIG. 1B show earbuds 10 and 12 that contain earbud rechargeable batteries 30 and 36 and earbud electrical contacts 32 and 34. The earbuds are outfitted with magnets 16 and 26 that allow a connection with earbud aperture magnets 66 and 76 (see FIG. 2) to ensure the earbuds remain securely retained within dock apertures 40 and 42 (also shown in FIG. 2). Although ring-shaped magnets are shown and described here, those of skill in the art will appreciate that other shapes and configurations of magnets (e.g., disk, bar) can generate sufficient magnetic attraction to securely retain the earbuds in their respective apertures. The magnets of the earbuds may be attracted to a metal component in the apertures. Alternatively or in addition, in any of the embodiments described in this document, the dock apertures (e.g., 40 and 42 in FIG. 2) may include one or more magnetic components, such as a magnetic coated surface or portion of the surface, or a magnetic strip, ring, disk or other structure, to help retain an earbud in the dock. Optionally, the dock aperture's magnet may have a polarity that is opposite that of one or more magnetic components of the earbuds, so that the earbud is held in the aperture via magnetic force. Such magnetic components may be made of any suitable material, such as ferrous magnets, ceramic magnets, electromagnets capable of electric conduction, or other magnetically polarized materials. The magnets may be permanent magnets or temporary magnets, such as those that exhibit a magnetic force after receiving a charge.

FIG. 1C illustrates an alternate embodiment in which the earbuds 10 and 12 include induction coils 77 and 83 for charging purposes. Each induction coil is electrically connected to its earbuds battery and configured to receive charge from an external source via induction and transfer the charge to the earbud's battery.

Wireless earbuds typically include internal components, such as acoustic components and transmitter and/or receiver components (e.g. Bluetooth®, or near field communication capabilities) that communicate wirelessly with a mobile smart phone or other device. These components may be connected to printed circuit boards PCB 3 and PCB 4 within the earbuds and may contain encoded software or firmware. The earbud tips 20 and 22 that contact the user's ear canal may be made from a soft material such as silicone, rubber, resin, photopolymer and the like produced by injection molding or anatomically customized for a user ear canal via 3D printing. The earbud grips 14 and 28 may have a diameter that is larger than that of the tips and may not contact the user's ear but provide a means for users to grasp and remove them from and ear. The grips 14 and 28 may be made of any plastic such as polycarbonate, polypropylene, polyvinyl chloride, photopolymer, resin, metal, alloy, rubber, or other compounds and available in a variety of hues. The earbuds 10 and 12 may also contain electrical contacts 32 and 34, such as one or more leads or prongs that are in contact with a rechargeable battery 30, 36. Each contact 32, 34 can receive a charge from an external source and direct the charge to its earbud's battery 30, 36. Each battery serves as a power source for the circuitry and speaker of its earbud.

FIG. 2 shows a charging dock 11 with a housing 55 that includes components to receive, store and charge in-ear hearing aids or other earbuds via apertures 40 and 42. As noted above, each aperture may include one or more magnets 66 and 76 to help secure the earbud in place. Earbuds contain speakers, and speakers contain magnets. Therefore, in certain embodiments, the earbud magnets 16 and 26 can be omitted and the earbuds can be held within the earbud apertures 40 and 42 by the magnetic attraction between the aperture magnetic contacts 66 and 76 and the magnet of a speaker within each earbud, respectively. The earbud apertures 40 and 42 may be shaped in a fashion to correspond to a shape of the tips of the earbuds 10 and 12 in FIG. 1A and FIG. 1B, and thus snugly house the earbuds in the housing.

The housing 55 may have a shape and dimension that corresponds to that of the earbud grips 14, 28 or other portions of the earbuds so that an earbud tip is received by the aperture but the earbud grip remains outside of the aperture, and optionally outside of the housing. For example, as shown in FIG. 2, the housing 55 may be cylindrical, each earbud grip (e.g., 14) may be circular, and the earbud housing may have a diameter that is substantially the same as that of the grip. The magnet 66 or other structure in the aperture, or even the depth of the aperture itself, serves as a stop when the earbud is placed in the housing. In this way, when an earbud tip is placed in an aperture, at least a portion of the earbud grip extends from the housing in an axial direction so that it may be gripped, while not exhibiting a size that extends substantially beyond the housing in a direction that is perpendicular to the axial direction. Alternatively, the housing 55 may have a non-cylindrical shape such as a rectangular prism shape, a spherical shape any other shape that permits the grips 14 to be at least partially exposed by being extended from the housing.

Each earbud aperture 40 and 42 may also contain one or more electrical contacts 37 and 39, such as leads or prongs, that are in electrical connection with other components of the dock as described below.

FIG. 2 also shows other internal components of dock 11, including a retractable and extendable electrical plug 44. The plug 44 may be a two-prong plug or 3-prong plug for connection to an alternating current (AC) wall receptacle. In certain embodiments, the plug 44 may be a direct current (DC) connector such as a universal serial bus (USB), USB mini, micro USB, lightning or other multi-pin connector a data port of an electronic device, an AC-DC converter, or other device, and contains electrical contacts that may be configured to connect to those devices. The earbud apertures 40 and 42 may be shaped in a fashion to correspond to a shape of the tips of the earbuds 10 and 12 in FIG. 1A and FIG. 1B, and thus snugly house the earbuds in the housing.

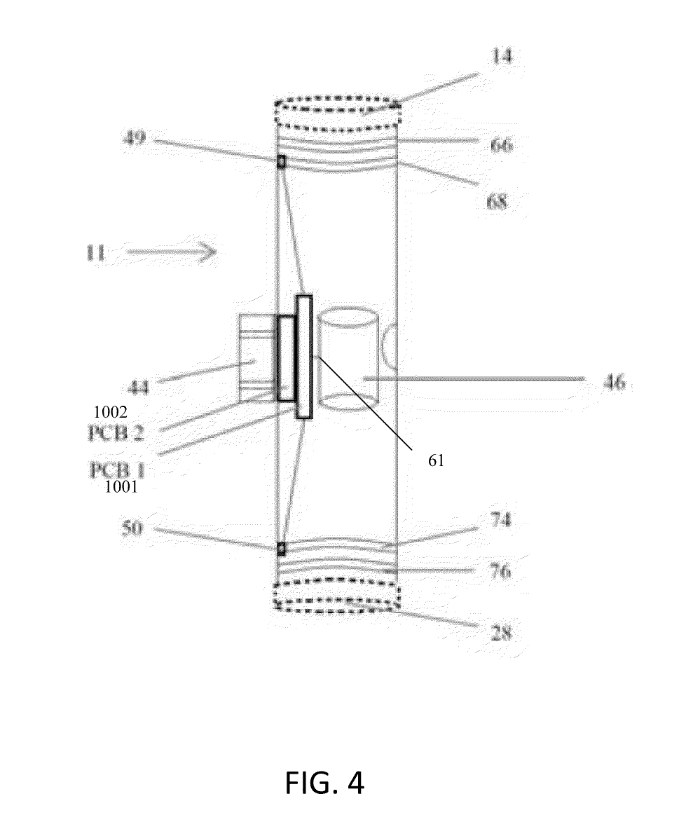

In a retraced position, the plug 44 will be held within a receptacle of the housing 55. A triggering member 48 such as a button, lever or switch may be activated by a user to release the plug 44 from its retracted position into its extended position. The button 48 may trigger an activation member 46 such as a string or lever that forces the plug 44 out of the housing, as seen in FIG. 4. The plug 44 may be retracted back into dock 11 when charging has completed. One of skilled art may appreciate that other forms of mechanical means besides a spring may be used to force plug 44 from dock 11 when triggering member 48 is activated. Alternatively, the plug may simply be mounted on an axle, slide or other structure that allows it to be manually pulled out of and pushed back into its receptacle of the housing.

Returning to FIG. 2, optionally, the earbud apertures 40 and 42 may have a semi hemispherical shape to allow a user to easily remove an earbud 10 and 12 from the apertures. In other embodiments, the earbud apertures may match the shape of the tips of the earbuds that they house, which may be of any shape designed to fit within a user's ear canal.

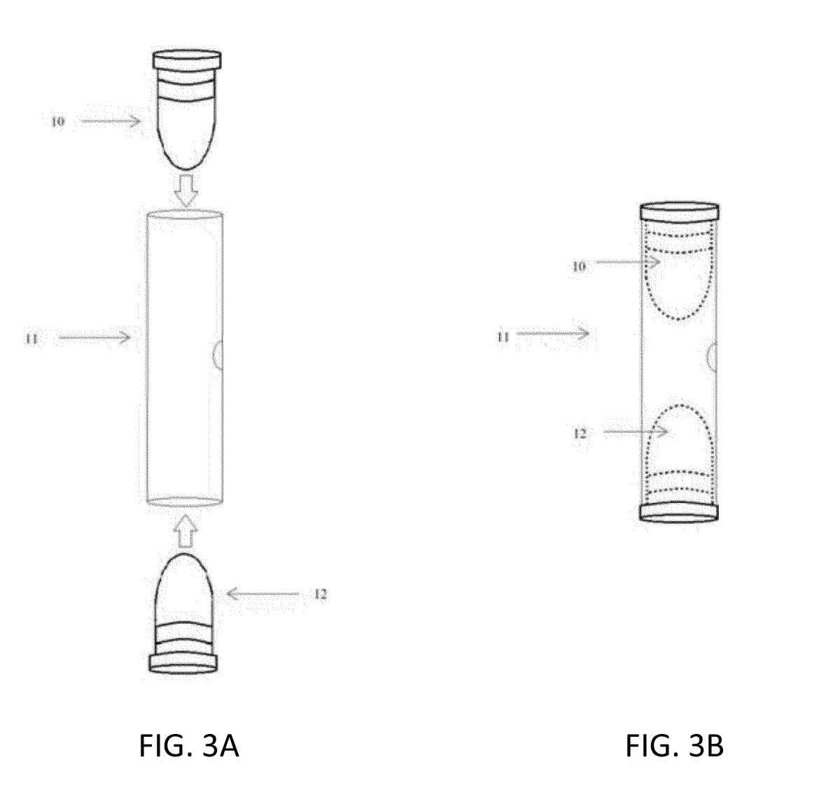

In certain embodiments, the earbuds can connect to the apertures via mechanical fit such as snap-fit or screw-in, in such a manner so that when securely stored, the electrical earbud contacts 32 and 34 and connect with aperture electrical contacts 68 and 74. In certain embodiments the electrical contacts may be ring shaped, or they may having another shape such as bar, circle, ledge or other geometry which allows for contact between the earbud electrical contacts and the aperture electrical contacts. FIG. 3A shows a front view of earbuds 10 and 12 entering dock 11. FIG. 3B shows a front view of earbuds 10 and 12 docked with dock 11. A user may insert a rechargeable earbud into the earbud apertures 10 and 12 to provide electrical charge via the earbud electrical contacts 68 and 74 shown in FIG. 4.

FIG. 4 also shows an example embodiment of internal electrical components of the dock 11. As shown in FIG. 4, there may be two (or any number of) printed circuit boards (or “PCBs”), shown as PCB1 1001, and PCB2 1002. PCB1 1001 is the main PCB in the example shown, and it may contain such items as a controller, firmware, an authentication chip, and a battery charging circuit. PCB2 1002 may contain a plug connector or multi-pin, such as a USB connector, 30-pin connector, Lightning connector or other connector. Main PCB 1001 connects to PCB2 1002 through a conductive element portion 1009 such as a cable, trace or bus. PCB1 1001 is electrically connected to plug 44 through PCB2 1002 and may transfer electrical charge to and from the rechargeable earbud batteries 30 and 36 via earbud electrical contacts 68 and 74 within dock 11.

Electrical components contained within dock 11 may include conductors and other components as wires, printed circuit boards, capacitors, resistors, and the like. The electrical components may transfer the charge from an external electrical power source, through the plug 44, to the earbud aperture electrical contacts 68 and 74 and to a rechargeable dock battery 46.

By being connected to the aperture electrical contacts 68 and 74, the electrical components may also allow the earbud batteries 30 and 36 to be charged when the earbuds 10 and 12 are placed in the earbud apertures 40 and 42 in the dock 11 when the dock's plug 44 is connected to a power source such as a computer's USB data port or a power outlet.

Electrical connectors that extend from the plug 44 will carry electric charge to both aperture electrical contacts 68 and 74 present within the open ends of the dock. Electrical connectors that extend from the plug 44 may also carry electric charge to a dock rechargeable battery 46 in parallel with supplying charge to aperture electrical contacts 68 and 74. The dock rechargeable battery 46 is also connected to Main PCB1 1001, which can route electric charge to electrical contacts 68 and 74 when the plug 44 is not engaged with a power source and earbud batteries 30 and 36 are not fully charged. Thus, either plug 44 or rechargeable dock battery 46 can supply charge to the dock's electrical earbud contacts 68 and 74.

The earbud apertures 40 and 42 may also contain electrical connectors/conductors, such as leads or prongs 50 and 48, that allow rechargeable earbud batteries 30 and 36 to receive electrical charge from the plug 44 via electrical earbud contacts 68 and 74. The connectors 49 and 50 will transfer electrical charge from the plug 44 to the earbud batteries 30 and 36 to the electrical contacts 68 and 74 contained within the apertures, which in turn transfer the charge to the earbud batteries 30 and 36 when earbuds are placed within the apertures. One or more additional connectors 61 may simultaneously transfer charge from the plug 44 to the dock battery 46 when the plug is connected to the power source. The connectors 61 that lead to the battery may also be in electrical contact with the connectors 49, 50 that lead to the earbud contacts so that when the plug is not connected to a power source, the battery 46 may discharge and transfer charge to the earbuds via the various connectors 49, 50 and 61 of the electrical components. Optionally, the dock 11 also may include a switch that enables a user to selectively open and close the circuit between the battery connectors 61 and the earbud connectors 49, 50 and thus control when the battery will serve to charge the earbuds. Optionally, the device may include a mechanical switch that automatically engages the battery connectors 61 with the earbud connectors 49, 50 when the plug 44 is in a retracted position, and which automatically disengages the battery connectors 61 from the earbud connectors 48, 50 when the plug 44 is in an extended position.

In certain embodiments, the aperture magnetic contact strips 66 and 76 may also serve as electrical contacts, delivering charge directly to the earbud magnetic contact strips from the plug 44 without the need for additional prongs or leaders. The earbuds 10 and 12 possess magnetic rings 16 and 26 which allow the earbuds to connect with aperture magnetic contact strips 66 and 76 embedded within earbud apertures 40 and 42 to hold the earbuds within the earbud apertures 40 and 42.

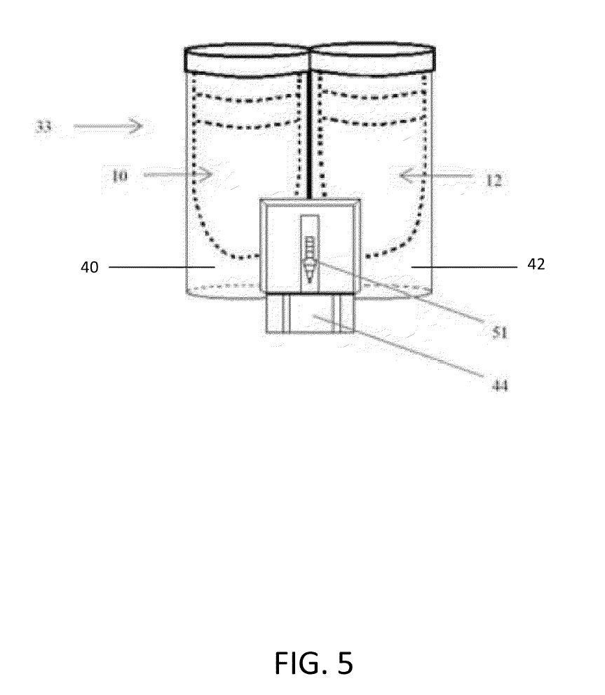

FIG. 5 shows an alternative configuration of an earbud dock 33, in which the earbud apertures 40 and 42 containing earbuds 10 and 12 are oriented adjacently and parallel rather than stacked along a single axis. Retractable plug 44 and activator 48 are also shown in an alternative configuration. The electrical and mechanical components within this alternative dock 33 may be those discussed in connection with FIG. 5 and consistent with dock 11.

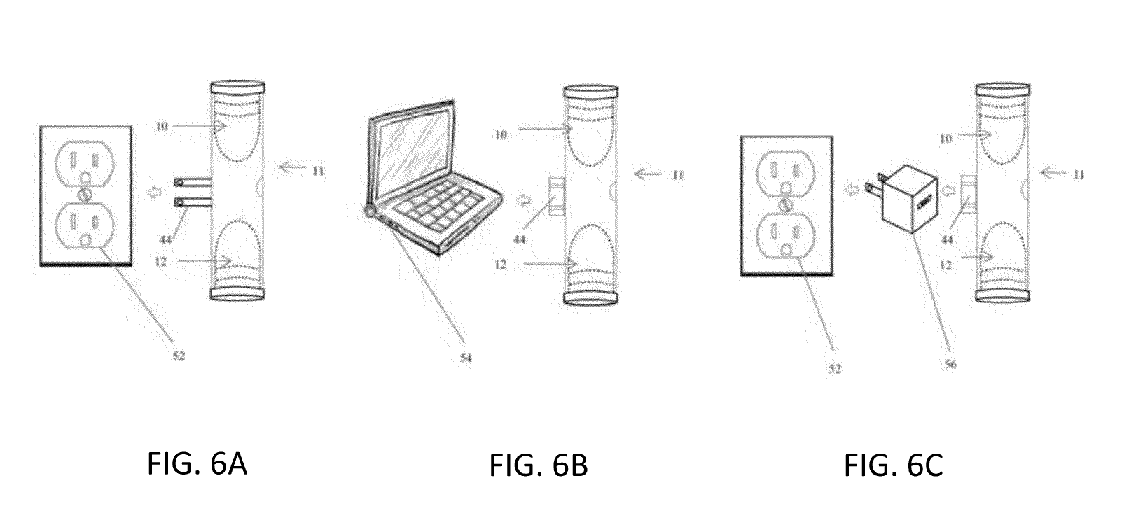

FIG. 6A shows dock 11 with extended plug 44 entering an electrical wall outlet 52.

FIG. 6B shows dock 11 with extended plug 44 entering the USB port of a computer.

FIG. 6C shows dock 11 with extended plug 44 entering a USB to AC adapter 56, which may then be attached to an electrical wall outlet 52.

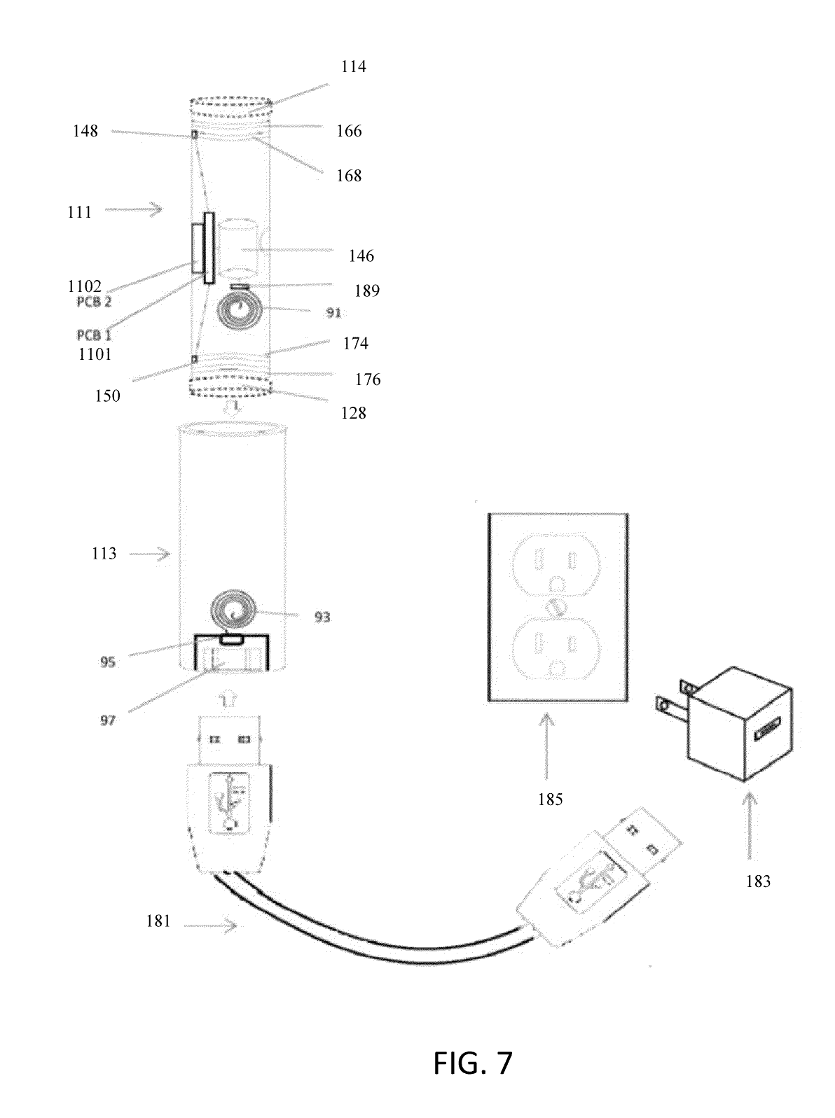

FIG. 7 illustrates a variations the dock of FIG. 4 in which earbuds 110 and 112 may receive power via dock induction coil 91 positioned within the dock 111. Alternatively, the earbuds 110 and 112 may receive charge via an induction coil 93 positioned within an induction charging station 113 that is shaped and sized to receive the dock 111 into an holding area such as a receptacle, seat or cradle. Or, the earbuds may be charged via a combination of the dock induction coil 91 and the charging station coil 93. This dock 111 may have other components similar to those shown in FIG. 4, such as: PCBs 1101 and 1102; grips 114 and 128; magnetic contact strips 166 and 176; aperture electrical contacts 168 and 174; a dock battery 146; and connectors 149 and 150 that lead from the battery 146, the induction coil 91 or both to the aperture electrical contacts 168 and 174. The induction coil may be attached to only the battery 146 so that it charges the battery, or it may be electrically connected to both the battery 146 and the connectors 149 and 150 to enable simultaneous charging of the battery and earbuds. The connectors 149 and 150 are optional, as in some embodiments if the earbuds are sufficiently proximate the induction coil (such as within a range of the coil's electromagnetic field), the connectors may not be needed.

The dock 111 itself may serve as the source of induction charge for earbuds by applying the current from a power input jack (as shown in any of FIGS. 6A-6C) to dock coil 91, which will create an electromagnetic field to inductively charge earbud batteries via earbud induction coils in conjunction with earbud electrical transformers 81 and 79. (See FIG. 1C.) Or, the charging station may include a power input jack 97 that connects to an external power source 185 via a cable 181 and 183. The station will include a contact 95 that electrically connects the jack 97 to the induction coil 93 to charge the coil when the power source is connected.

The dock coil 91 may be associated with an aperture of the dock 111 by being electrically connected to the aperture, or simply by being positioned proximal to the aperture so that an electromagnetic field generated by the aperture coil will extend to its associated aperture. Thus, the coil of the dock may inductively couple with the coils of the earbuds so that energy transfers from the dock coil 91 to the earbud coils 77 and 83.

Alternatively, an external induction charging unit 113 such as a charging tube, mat, tray, cradle seat or other device can contact and receive the dock 111 and energize dock coil 91 when in the presence of the induction charging unit 113. In this instance the charging station coil 93 can inductively couple with the dock coil 91 which can then either inductively charge the earbuds or convert the electromagnetic field into direct current via a transformer and directly provide charge to the earbud aperture electrical contacts (using structure such as that shown in FIG. 4).

In a third variation, the external induction charging unit can transfer charge directly to earbud coils, when the earbuds are placed in the induction charging station 113, or within the range of an electromagnetic field generated by the station when the station is connected to a power source, within or without dock 111. In this configuration, when dock 111 is placed within the range of an electromagnetic field of an induction charging unit, the induction coil 91 or coils embedded within the dock will create an electromagnetic field that the earbuds will enter when placed in the earbud apertures. With additional reference to FIG. 1C, additional induction coils 77 and 83 embedded within each of the earbuds transform the electromagnetic field created by dock coil 91 into electric current via earbud electrical transformers 79 and 81. The earbud induction coils 77 and 83 direct the electric current to earbud rechargeable batteries 30 and 36, thus delivering at least partial charge to the earbuds 10 and 12.

In some embodiments, any of the dock embodiments shown above may be provided as a kit or system with one or more earbuds, a charging station, external plug and/or a power cord.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A system for recharging one or more earbuds, the system comprising:
a housing having a first end with a first earbud receiving aperture and an opposite second end with a second earbud receiving aperture, wherein each earbud receiving aperture is configured to receive an earbud into the housing and comprises a magnetic component configured to engage a corresponding magnetic component of the earbud to secure the earbud within the earbud receiving aperture; and
a power transfer component; and
one or more electrical contacts that are configured to transfer power from the power transfer component to the earbuds when the power transfer component exhibits a charge and the earbuds are magnetically held within the earbud receiving apertures.

2. The system of claim 1, wherein the power transfer component comprises:
a plug that is moveable between an extended position and a retracted position and configured to receive charge from a power source via the plug when the plug is connected to the power source;
a rechargeable dock battery; and
a conductive element that, when the extended plug is connected to a power source, electrically connects the plug to the one or more electrical contacts and to the rechargeable dock battery to enable a simultaneous charge of the rechargeable dock battery and of each earbud when placed in its earbud receiving aperture.

3. The system of claim 2, wherein the plug comprises a mechanically extendable AC connector or multi-pin connector.

4. The system of claim 2, wherein the conductive element is also configured to transfer charge from the rechargeable battery to the one or more electrical contacts when the plug is not connected to a power source.

5. The system of claim 2, further comprising:
a spring; and
an activator that, when activated, causes the spring to force the plug from the retracted position to the extended position.

6. The system of claim 1, wherein the power transfer component comprises:
a rechargeable dock battery;
an induction coil; and
a conductive element that electrically connects the induction coil to the rechargeable dock battery and the electrical connectors to enable a simultaneous charge of the rechargeable dock battery and of each earbud when placed in its earbud receiving aperture and when the induction coil is energized.

7. The system of claim 6, further comprising:
an induction charging unit comprising a charging unit induction coil, and one or more components configured to electrically connect the induction coil to a power source so that the charging unit induction coil energizes when electrically connected to the power source;
wherein the charging unit is configured to receive the housing and transfer charge from the charging unit induction coil to the dock induction coil when the housing is proximate the charging unit.

8. The system of claim 1, wherein:
each earbud comprises a grip having a circular shape and a lateral dimension; and
the housing comprises a cylindrical shape and lateral dimension corresponding to that of a grip of each earbud so that when an earbud is placed in one of the earbud receiving apertures, its earbud grip will extend from the housing.

9. The system of claim 1, wherein the magnetic component of each earbud receiving aperture comprises a magnetic coated surface, ring, strip or disk.

10. The system of claim 1, wherein the magnetic component of each earbud comprises a magnetic ring, disk or bar.

11. The system of claim 1, wherein the magnetic component of each earbud comprises a speaker.

12. The system of claim 1, wherein the magnetic component of each earbud receiving aperture has a first polarity, and the magnetic component of each earbud has a second polarity that is opposite the first polarity.

13. A system for recharging one or more earbuds, the system comprising:
one or more earbuds, wherein each earbud comprises:
a grip having a shape,
a lateral dimension, and
a magnetic component; and
a housing comprising:
one or more earbud receiving apertures,
wherein each earbud receiving aperture is configured to receive one of the earbuds and comprises a magnetic component configured to engage the corresponding magnetic component of the received earbud to secure the received earbud within the earbud receiving aperture,
wherein the magnetic component of each earbud receiving aperture has a first polarity, and the magnetic component of each earbud has a second polarity that is opposite the first polarity, and
wherein the housing has a shape and lateral dimension corresponding to that of a grip of each earbud so that when an earbud is placed in one of the earbud receiving apertures, its earbud grip will extend from the housing
a power transfer component; and
one or more electrical contacts that are configured to transfer power from the power transfer component to the earbuds when the power transfer component exhibits a charge and the earbuds are magnetically held within the earbud receiving apertures.

14. The system of claim 13, wherein the power transfer component comprises:
a plug that is moveable between an extended position and a retracted position and configured to receive charge from a power source via the plug when the plug is connected to the power source;
a rechargeable dock battery; and
a conductive element that, when the extended plug is connected to a power source, electrically connects the plug to the one or more electrical contacts and to the rechargeable dock battery to enable a simultaneous charge of the rechargeable dock battery and of each earbud when placed in its earbud receiving aperture.

15. The system of claim 14, wherein the plug comprises a mechanically extendable AC connector or multi-pin connector.

16. The system of claim 14, wherein the conductive element is also configured to transfer charge from the rechargeable battery to the one or more electrical contacts when the plug is not connected to a power source.

17. The system of claim 12, further comprising:
a spring; and
an activator that, when activated, causes the spring to force the plug from the retracted position to the extended position.

18. The system of claim 13, wherein the power transfer component comprises:
a rechargeable dock battery;
an induction coil; and
a conductive element that electrically connects the induction coil to the rechargeable dock battery and the electrical connectors to enable a simultaneous charge of the rechargeable dock battery and of each earbud when placed in its earbud receiving aperture and when the induction coil is energized.

19. The system of claim 18, further comprising:
an induction charging unit comprising a charging unit induction coil, and one or more components configured to electrically connect the induction coil to a power source so that the charging unit induction coil energizes when electrically connected to the power source;
wherein the charging unit is configured to receive the housing and transfer charge from the charging unit induction coil to the dock induction coil when the housing is proximate the charging unit.

20. The system of claim 13, wherein:
the magnetic component of each earbud receiving aperture comprises a magnetic coated surface, ring, strip or disk; and
the magnetic component of each earbud comprises a speaker, or a magnetic ring, disk or bar.
